(19) United States
(12) Patent Application Publication
(10) Pub. No.: US 2021/0065582 A1
(43) Pub. Date: Mar. 4, 2021

(54) Method and System of Providing Speech Rehearsal Assistance

(71) Applicant: MICROSOFT TECHNOLOGY LICENSING, LLC, Redmond, WA (US)

(72) Inventors: Huakai LIAO, Vancouver (CA); Kevin Dara KHIEU, East Palo Alto, CA (US); Amit SRIVASTAVA, San Jose, CA (US); Huey-Ru TSAI, Los Altos, CA (US); Gregory Alexander DEPAUL, San Mateo, CA (US); John Christian LEONE, Milpitas, CA (US); Hemin Kiran Merchant, Newark, CA (US)

(73) Assignee: MICROSOFT TECHNOLOGY LICENSING, LLC, Redmond, WA (US)

(21) Appl. No.: 16/560,783

(22) Filed: Sep. 4, 2019

(51) Int. Cl. G09B 19/04; G10L 15/02; G10L 15/22; G10L 25/90; G10L 15/16; G09B 5/02; G06N 3/04

(52) U.S. Cl. CPC G09B 19/04; G10L 15/02; G10L 15/22; G10L 2015/027; G10L 15/16; G09B 5/02; G06N 3/04; G10L 25/90

(57) ABSTRACT

A method and system for speech rehearsal assistant during a presentation rehearsal includes receiving audio data from a speech rehearsal session over a network, receiving a transcript for the audio data, the transcript including a plurality of words spoken during the speech rehearsal session, calculating a real time speaking rate for the speech rehearsal session, determining if the speaking rate is within a threshold range, detecting utterance of a filler phrase or sound during the speech rehearsal session using at least in part a machine learning model trained for identifying filler phrases and sounds in a text, and upon determining the speaking rate falls outside the threshold range or detecting the utterance of the filler phrase or sound, enabling real time display of a notification on a display device.

### BACKGROUND

Many people struggle with public speaking, particularly when it involves giving a presentation or a speech. In fact, fear of public speaking is one of people's most common fears. This type of fear often affects the quality of a person's speech. For example, when nervous, some people begin speaking too fast. Others begin talking too slow, pausing too long in between words, using too many filler words or being disfluent in their speech.

A common method of decreasing nervousness and improving the quality of a person's speech is to practice giving the speech beforehand. This may be done in front of a mirror to examine the body language. While this may be helpful in correcting improper or distracting body language, it does not always help the speaker identify speaking issues. For example, it may be difficult for a person practicing a speech to realize some of the shortcomings of theft speech and determine how to improve it, even if they are practicing in front of a mirror.

Hence, there is a need for improved systems and methods of providing speech rehearsal assistance.

### SUMMARY

In one general aspect, the instant disclosure presents a data processing system having a processor and a memory in communication with the processor wherein the memory stores executable instructions that, when executed by the processor, cause the data processing system to perform multiple functions. The function may include receiving audio data from a speech rehearsal session over a network, the speech rehearsal session being performed for a digital presentation, receiving a transcript for the audio data, the transcript including a plurality of words spoken during the speech rehearsal session, determining a number of syllables in each of the plurality of words, calculating a speaking rate based at least in part on the number of syllables, determining if the speaking rate is within a threshold range, and enabling display of a notification on a display device in real time, if the speaking rate falls outside the threshold range.

In yet another general aspect, the instant disclosure presents a data processing system having a processor and a memory in communication with the processor wherein the memory stores executable instructions that, when executed by the processor, cause the data processing system to perform multiple functions. The function may include receiving audio data from a speech rehearsal session over a network, receiving a transcript for the audio data, the transcript including a plurality of words spoken during the speech rehearsal session, detecting utterance of a filler phrase or sound during the speech rehearsal session using at least in part a machine learning model trained for identifying filler phrases and sounds in a text, upon detecting the utterance of the filler phrase or sound, enabling real time display of a notification on a display device, wherein detecting the utterance of the filler phrase or sound is done based on at least one of the transcript of the audio data or the audio data.

In a further general aspect, the instant application describes a non-transitory computer readable medium on which are stored instructions that when executed cause a programmable device to receiving audio data from a speech rehearsal session over a network, the speech rehearsal session being performed for a digital presentation, receiving a transcript for the audio data, the transcript including a plurality of words spoken during the speech rehearsal session, determining a number of syllables in each of the plurality of words, calculating a speaking rate based at least in part on the number of syllables, determining if the speaking rate is within a threshold range, and enabling display of a notification on a display device in real time, if the speaking rate falls outside the threshold range.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

The drawing figures depict one or more implementations in accord with the present teachings, by way of example only, not by way of limitation. In the figures, like reference numerals refer to the same or similar elements. Furthermore, it should be understood that the drawings are not necessarily to scale.

FIG. 1 depicts an example system upon which aspects of this disclosure may be implemented.

FIG. 2 depicts an example user interface screen for an application or service that provides speech or presentation rehearsal assistance.

FIGS. 3A-3D depict example user interface screens of an application providing a presentation rehearsal session.

FIG. 4 depicts an example user interface screen displaying a summary diagnostic feedback report for a presentation rehearsal session.

FIG. 5 is a flow diagram depicting an example method for providing speech rehearsal assistance.

FIG. 6 is a block diagram illustrating an example software architecture, various portions of which may be used in conjunction with various hardware architectures herein described.

FIG. 7 is a block diagram illustrating components of an example machine configured to read instructions from a machine-readable medium and perform any of the features described herein.

### DETAILED DESCRIPTION

In the following detailed description, numerous specific details are set forth by way of examples in order to provide a thorough understanding of the relevant teachings. It will be apparent to persons of ordinary skill, upon reading this description, that various aspects can be practiced without such details. In other instances, well known methods, procedures, components, and/or circuitry have been described at a relatively high-level, without detail, in order to avoid unnecessarily obscuring aspects of the present teachings.

Fear of public speaking is often ranked as one of people's worst fears. Yet, giving presentations and occasional speeches is part of many careers and activities, and as such a common occurrence for many people. When a person is nervous or uncomfortable, their normal manner of speaking may be altered without them even realizing it. For example, they may begin speaking either too fast or too slow. Other times, they may begin using too many filler words, or being otherwise disfluent.

A common solution for improving the quality of a presentation or speech is to practice beforehand. This may be done in front of a mirror, for example, to observe body language, or if possible, in front of another person who can point out shortcomings that the presenter may be unaware of. Practicing in front of a mirror, however, does not always result in the speaker being able to identify issues in their speech. For example, when you are focused on examining your body language, you may not notice the rate of your speech or realize that you are using too many filler words. However, practicing in front of another person is not always an option. Furthermore, even if that is a possibility, the person may not be able to point out the different issues.

Some currently available programs provide for measuring a person's speaking rate which is one of the factors that affect speech. However, these currently available programs calculate the speaking rate as the average words spoken per a given unit of time (e.g., per minute). This may be sufficient as general information. However, it does not provide specific real-time information regarding which portions of a speech are too fast or too slow. Furthermore, the speaking rate calculated may not be accurate as it does not take into account factors such as, pauses or the length of the words spoken. Thus, people are often left with inadequate or inaccurate mechanisms for receiving feedback for speech or presentation rehearsals.

To address these technical problems and more, in an example, this description provides technical solutions for providing real-time feedback regarding the quality of a person's speech. In an example, a person's speaking rate is calculated and provided to the user in real-time. This may be achieved by utilizing a speech recognition algorithm that converts spoken words to text in real-time, determining the number of syllables in the words spoken for a given time period and calculating the speaking rate based on the number of syllables, instead of the number of words. Furthermore, phonetic features of the audio signal such as pitch, intensity or energy (e.g., formant) may be taken into account to determine the speaking rate. In another example, utterance of filler words and sounds or disfluency in speech may be detected and notification may be provided to the speaker in real-time to inform the user of issues they need to address as they are speaking.

This may be done by examining the speech transcript to identify filler words. In one implementation, a machine learning (ML) model may be utilized to detect words that are not necessary to the sentence and identify those as filler words. Furthermore, the audio data may be examined to identify features such as pitch, intensity and frequency, among others to determine when there are extended vowel sounds which may be indicative of filler words (e.g., “um” and “uh”) and detect filler pauses. As a result, the solution provides an improved method of providing real time feedback to a speaker during a speech rehearsal to increase the quality of a person's speech or presentation.

As will be understood by persons of skill in the art upon reading this disclosure, benefits and advantages provided by such implementations can include, but are not limited to, a solution to the technical problems of inaccurate and inadequate feedback provided to a speaker during a speech rehearsal. Technical solutions and implementations provided here optimize the quality of calculating a speaking rate, provide the speaking rate and information about filler words or other speaking disfluency, and provide the feedback in real time to help the user address the shortcomings as they are speaking. The benefits made available by these solutions provide a user-friendly mechanism for receiving feedback regarding a presentation or speech.

As a general matter, the methods and systems described herein may include, or otherwise make use of, a machine-trained model to identify contents related to a text. Machine learning (ML) generally involves various algorithms that can automatically learn over time. The foundation of these algorithms is generally built on mathematics and statistics that can be employed to predict events, classify entities, diagnose problems, and model function approximations. As an example, a system can be trained using data generated by a ML model in order to identify patterns in user activity, determine associations between various words and contents (e.g., icons, images, or emoticons) and/or identify filler words or speaking disfluency in speech. Such determination may be made following the accumulation, review, and/or analysis of user data from a large number of users over time, that may be configured to provide the ML algorithm (MLA) with an initial or ongoing training set. In addition, in some implementations, a user device can be configured to transmit data captured locally during use of relevant application(s) to the cloud or the local ML program and provide supplemental training data that can serve to fine-tune or increase the effectiveness of the MLA. The supplemental data can also be used to facilitate identification of contents and/or to increase the training set for future application versions or updates to the current application.

In different implementations, a training system may be used that includes an initial ML model (which may be referred to as an “ML model trainer”) configured to generate a subsequent trained ML model from training data obtained from a training data repository or from device-generated data. The generation of this ML model may be referred to as “training” or “learning.” The training system may include and/or have access to substantial computation resources for training, such as a cloud, including many computer server systems adapted for machine learning training. In some implementations, the ML model trainer is configured to automatically generate multiple different ML models from the same or similar training data for comparison. For example, different underlying ML algorithms may be trained, such as, but not limited to, decision trees, random decision forests, neural networks, deep learning (for example, convolutional neural networks), support vector machines, regression (for example, support vector regression, Bayesian linear regression, or Gaussian process regression). As another example, size or complexity of a model may be varied between different ML models, such as a maximum depth for decision trees, or a number and/or size of hidden layers in a convolutional neural network. As another example, different training approaches may be used for training different ML models, such as, but not limited to, selection of training, validation, and test sets of training data, ordering and/or weighting of training data items, or numbers of training iterations. One or more of the resulting multiple trained ML models may be selected based on factors such as, but not limited to, accuracy, computational efficiency, and/or power efficiency. In some implementations, a single trained ML model may be produced.

The training data may be continually updated, and one or more of the models used by the system can be revised or regenerated to reflect the updates to the training data. Over time, the training system (whether stored remotely, locally, or both) can be configured to receive and accumulate more and more training data items, thereby increasing the amount and variety of training data available for ML model training, resulting in increased accuracy, effectiveness, and robustness of trained ML models.

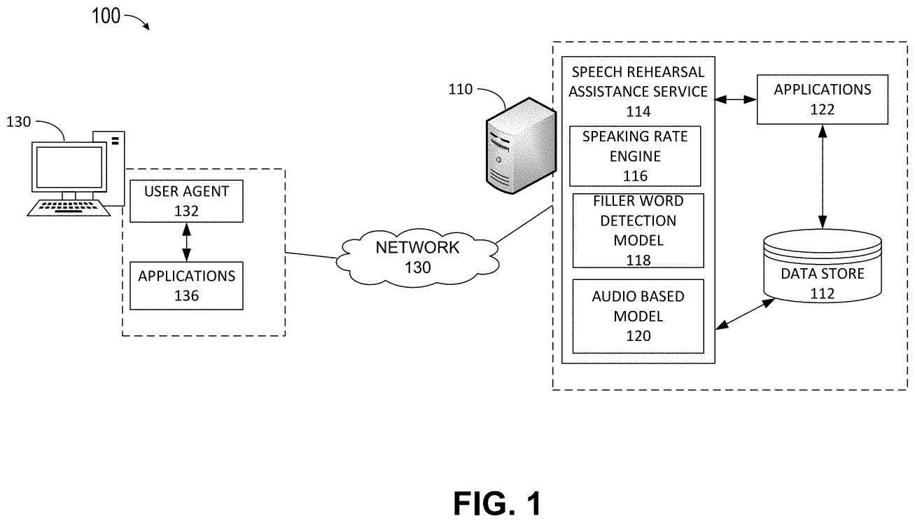

FIG. 1 illustrates an example system 100, upon which aspects of this disclosure may be implemented. The system 100 may include a sever 110 which may be connected to or include a data store 112 which may function as a repository in which datasets relating to training models, data relating to the speech rehearsal assistance service and/or data relating to applications 122 may be stored. Although shown as a single data store, the data store 112 may be representative of multiple storage devices and data stores which may be connected to each of the speech rehearsal assistance service 114, applications 122 or models 118 and 120. Moreover, the sever 110 may include a plurality of servers that work together to deliver the functions and services provided by each service or application. The server 110 may operate as a shared resource server located at an enterprise accessible by various computer client devices such as client device 130. The server may also operate as a cloud-based server for offering speech rehearsal assistance services in one or more applications such as applications 122.

The server 110 may include and/or execute a speech rehearsal assistance service 114 which may provide intelligent speech rehearsal feedback for users utilizing an application on their client devices such as client device 130. The speech rehearsal assistance service 114 may operate to examine data received from a user's client device via an application (e.g., applications 122 or applications 136), examine the data and provide feedback to the user regarding their speech or presentation. In an example, the speech rehearsal assistance service 114 may utilize a speaking rate engine 116, a filler word detection model 118, and an audio based model 120 to examine the user's speech and provide feedback regarding the user's speaking rate and/or use of filler words and their fluency. For example, the speaking rate engine may be used to calculate the user's speaking rate by utilizing various mechanisms which may include examining the audio data to identify the syllable nuclei in each word for calculating the number of syllables before determining the speaking rate. The filler word detection model, on the other hand, may examine the transcript of the audio data to determine if any words in the transcript correspond to filler words, sounds or phrases. Similarly, the audio-based model may examine the audio data to detect filler words and/or other disfluencies based on audio data. Other models may also be used.

Each of the models used as part of the speech rehearsal assistance service may be trained by a training mechanism such as mechanism known in the art. The training mechanism may use training datasets stored in the datastore 112 or at other locations to provide initial and ongoing training for each of the models 118 and 120. In one implementation, the training mechanism may use labeled training data from the datastore 112 (e.g., stored user input data) to train each of the models 118 and 120, via deep neural networks. The initial training may be performed in an offline stage.

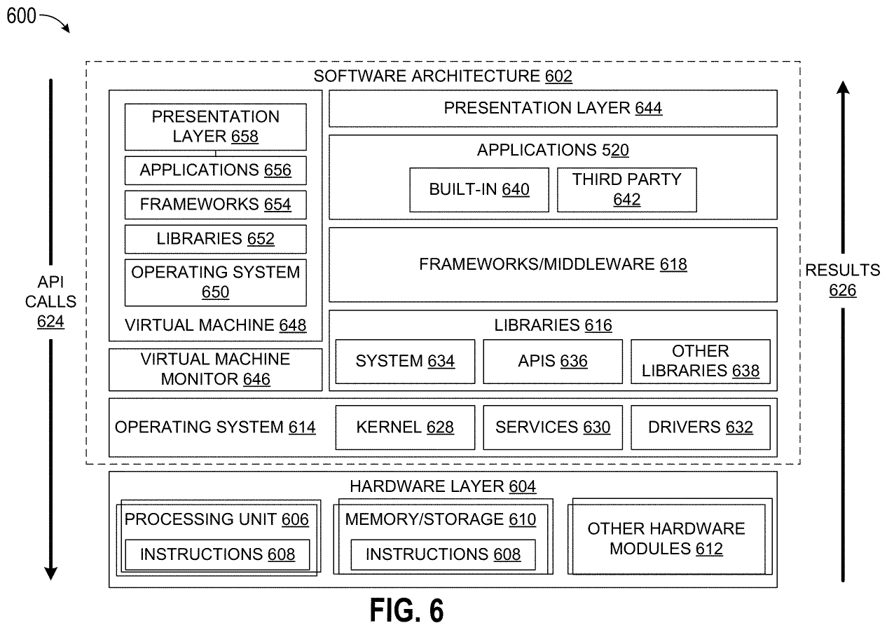

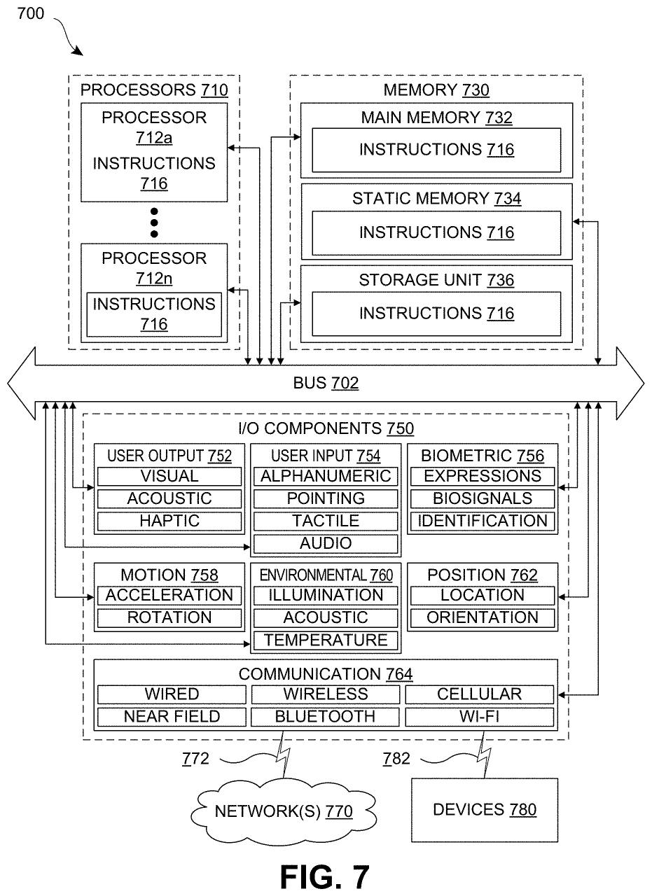

The client device 130 may be connected to the server 110 via a network 130. The network 130 may be a wired or wireless network(s) or a combination of wired and wireless networks that connect one or more elements of the system 100. The client device 130 may be a personal or handheld computing device having or being connected to input/output elements that enable a user to interact with various applications (e.g., applications 122 or applications 136). Examples of suitable client devices 130 include but are not limited to personal computers, desktop computers, laptop computers, mobile telephones; smart phones; tablets; phablets; smart watches; wearable computers; gaming devices/computers; televisions; and the like. The internal hardware structure of a client device is discussed in greater detail in regard to FIGS. 6 and 7.

The client device 130 may include one or more applications 136. Each application 136 may be a computer program executed on the client device that configures the device to be responsive to user input to allow a user to provide audio input in the form of spoken words via the application 136. Examples of suitable applications include, but are not limited to, a productivity application (e.g., job searching application that provides a job interview coach or a training application that trains employees such as customer service staff on responding to customers, etc.), presentation application (e.g., Microsoft PowerPoint), a document editing application, communications application or a standalone application designed specifically for providing speech rehearsal assistance.

In some examples, applications used to receive user audio input and provide feedback may be executed on the server 110 (e.g., applications 122) and be provided via an online service. In one implementation, web applications may communicate via the network 130 with a user agent 132, such as a browser, executing on the client device 130. The user agent 132 may provide a user interface that allows the user to interact with applications 122 and may enable applications 122 to provide user data to the speech rehearsal assistance service 114 for processing. In other examples, applications used to receive user audio input and provide feedback maybe local applications such as the applications 136 that are stored and executed on the client device 130 and provide a user interface that allows the user to interact with application. User data from applications 136 may also be provided via the network 130 to the speech rehearsal assistance service 114 for use in providing speech rehearsal feedback.

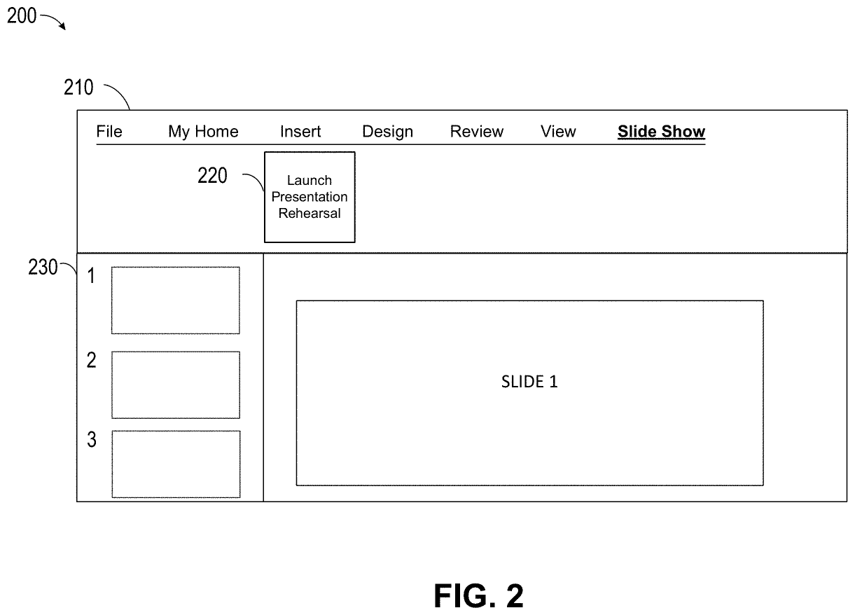

FIG. 2 depicts an example user interface (UI) screen 200 for an application or service that provides speech or presentation rehearsal. The UI screen 200 of FIG. 2A may for example be displayed by a presentation application that is also used for preparing presentation materials (e.g., digital presentation slides) for display during a presentation. In an example, the UI screen 200 of the presentation application or service may include a toolbar menu 210 that may display multiple tabs for providing various menu options. The UI screen 200 may also include a content pane 230 which may contain one or more sections. In an example, the content pane 230 may include a section for displaying thumbnails of the slides in the presentation and a section for displaying in a larger size a selected slide from among the slides shown on the left.

One of the tabs of the toolbar menu 210, such as the Slide Show tab selected in the UI screen 200 may include a UI element such as menu option 220 for launching a presentation rehearsal. Selecting the menu option 220 may lead to entering a presentation mode where the slides are shown in a full screen mode on a display screen associated with the client device. However, in addition to entering a normal presentation mode, selecting the menu option 220 may also lead to the client device beginning to start a presentation rehearsal session. In one implementation, entering the presentation rehearsal session may cause the client device to begin capturing (e.g., by a microphone), processing, and/or transmitting audio data for providing feedback to the user. It should be noted that although the launch presentation option is shown as being part of a menu option of a menu toolbar, any other UI element may be used to begin a presentation rehearsal session. Furthermore, although the launch presentation option is displayed as being a part of a presentation application, it does not have to be. Any other application or service that can capture audio data and provide a display screen for displaying feedback regarding the user's speech may be used.

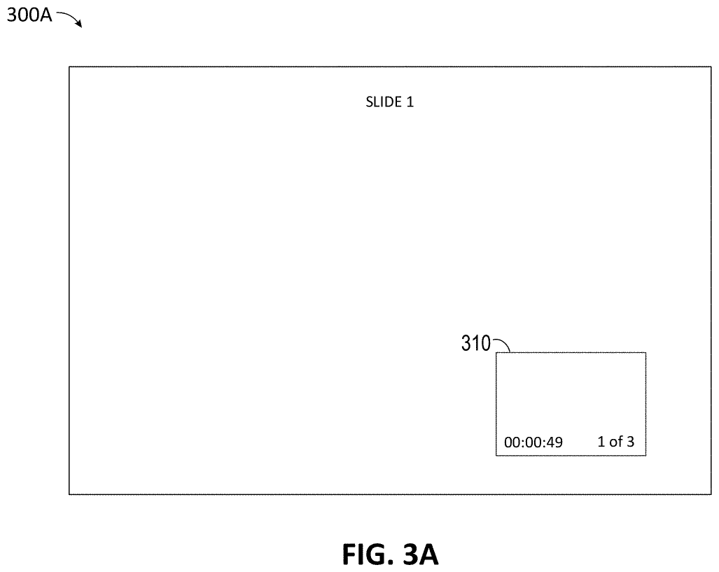

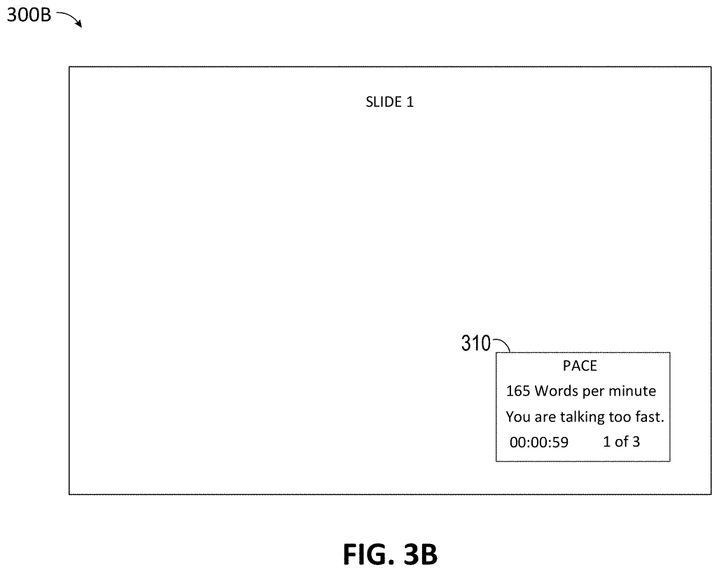

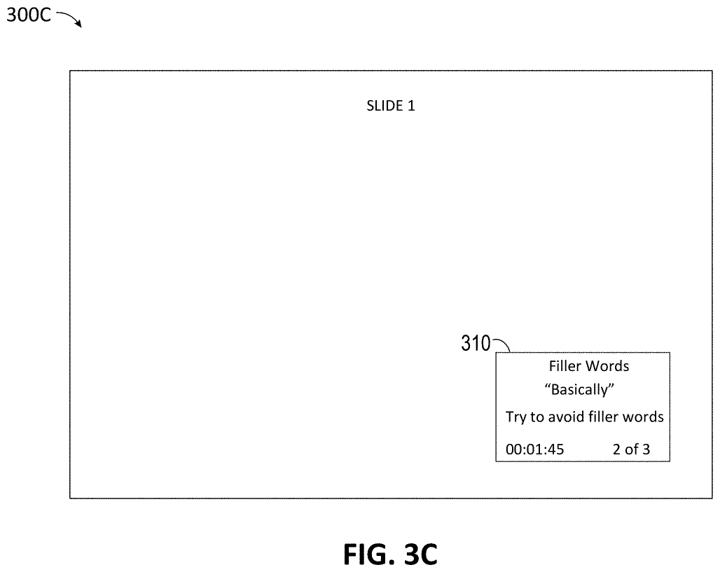

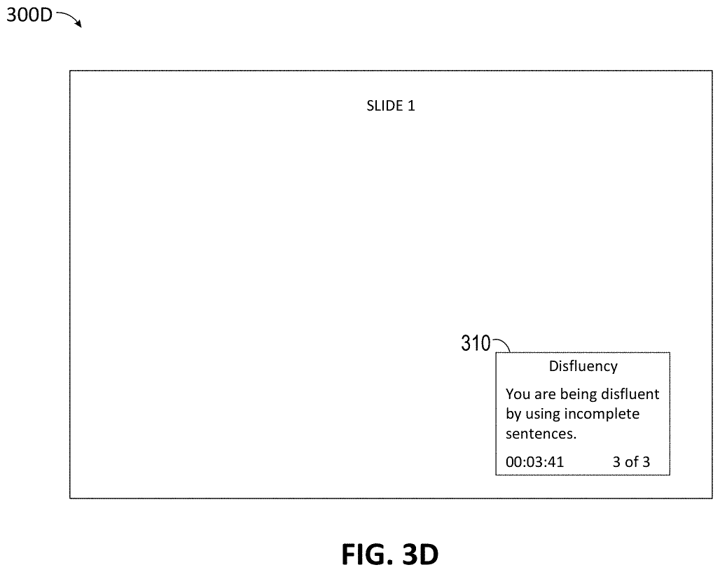

FIGS. 3A-3D illustrate example UI screens of an application providing a presentation rehearsal session. The UI screen 300A of FIG. 3A may for example be displayed by the presentation application of FIG. 2 once the user selects the launch presentation option 220 and begins speaking. In an example, once the presentation session begins, a UI element 310 (e.g., a pop-up menu) may be displayed on the UI screen 300A to provide real-time feedback to the user. However, although a UI element 310 is shown in FIGS. 3A-3D, it should be understood that many other configurations for providing feedback to the user may be utilized. For example, audio feedback may be provided when a notification regarding an issue detected with the presentation is to be provided. In another example, feedback may be provided on a separate screen from the presentation screen. Other configurations are also possible.

In one implementation, the UI element 310 may be displayed on the screen as soon as a presentation rehearsal session is started. In an alternative implementation, the UI element 310 may only be displayed when there is a need to display a notification (e.g., abnormal pace, use of filler words, and the like). In situations where the UI element 310 is displayed as soon as the presentation is started, the UI element may be used to display a timer providing the amount of time passed since the user started their speech or presentation. Additionally, the UI element may display the number of the slide the presenter is on and the total number of slides in the presentation. This information may be helpful to the user in determining how much time they have spent so far and how much time they may still need for the remaining presentation. For example, if the timer shows that the user has been speaking over five minutes and is still on the first slide, and the user knows that they have a total of 10 minutes to cover 3 slides, they may realize that they are speaking too slowly or spending too much time covering the first slide. This may inform the user that they need to change their pace or balance their focus to finish on time.

FIG. 3B depicts an example UI Screen 300B where the UI element 310 is used to notify the user about their pace. This may occur for example when the speech rehearsal assistance service determines that the speaking rate is outside a predetermined range. For example, if a normal speaking pace is determined to be in the range of 100 to 150 words per minute, a determination that the user's speaking rate is higher than the upper hand of the predetermined range may result in displaying a notification about the user's pace. In the example provided in FIG. 3B, the user's speaking rate is determined to be 165 which is indicative of a fast pace. As a result, a notification is shown to the user in real-time to notify the user that they should slow down. Similar notifications may be displayed when a slow pace is identified. In one implementation, the user may also be notified of their pace when they have a normal speaking rate to provide encouragement.

FIG. 3C depicts an example UI Screen 300C where the UI element 310 is used to notify the user about use of filler words. This may occur when the speech rehearsal assistance service detects the use of one or more filler words in the user's speech. In one implementation, every time, the service detects a filler word, a warning such as the one shown in the UI element 310 of FIG. 3C may be displayed which identifies the filler word used. This helps discourage the use of filler words in real-time as the user is speaking. In instances where more than one filler words are detected within a short span of time, the warning may list the filler words used. This may help the user become mindful of the phrases they are using so that they can correct their speech while they are rehearsing. If they continue using filler words, the program may continue displaying notifications. This can be very helpful in assisting a user improve their public speaking and presentation skills.

FIG. 3D depicts an example UI Screen 300D where the UI element 310 is used to notify the user about disfluency. This may occur when inflection points are identified in the speech. In an example, disfluency may also be identified when the user makes long pauses in the middle of a sentence, when they repeat one or more words in the middle of a sentence, when there are incomplete sentences or when grammatically incorrect sentences or phrases are identified. without completing the sentence. In such cases, a notification may be displayed in the UI element 310 to inform the user of their disfluency. In an example, the notification may provide information about how the user is being disfluent. This may assist the user in addressing the issue.

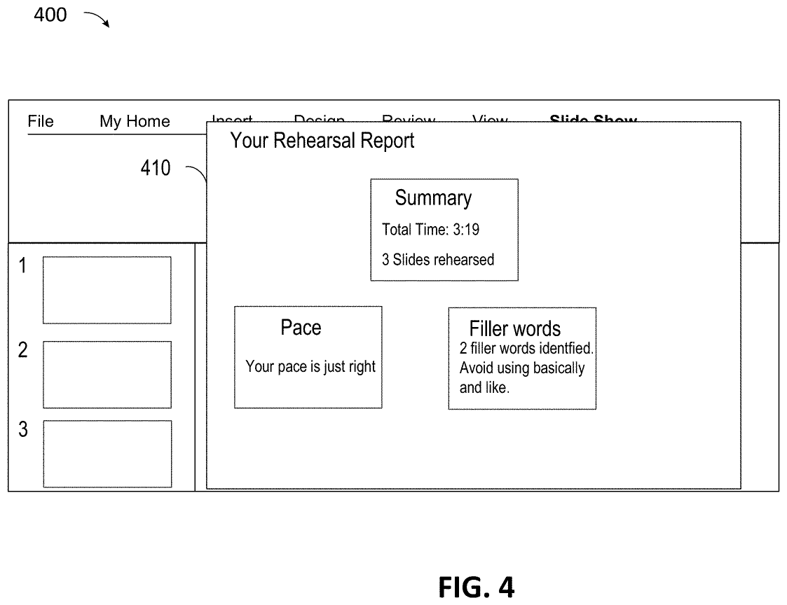

In one implementation, in addition to the notifications provided in real-time, a summary report may also be provided to the user after the rehearsal session is complete. The summary report may provide an overall assessment of the users' performance and may include information such as the overall pace of speaking, the number and list of most frequently used filler words, the number of times the user was disfluent, the total time used for rehearsal, and the like. FIG. 4 depicts an example UI screen 400 displaying a summary report for a presentation rehearsal session. The summary report may be displayed via a UI element 410 such as the pop-up screen shown in FIG. 4. Alternative configurations for displaying the summary report are also contemplated. For example, a text document providing the report may be provided for viewing, downloading and/or storing for future reference.

In one implementation, the UI element 410 may be displayed automatically when the application receives an indication that the presentation session has ended. This may occur for example, when the user exits the presentation mode. In another example, a link for the summary report may be provided upon exiting the presentation, upon selection of which the report may be displayed. The summary report may include the total presentation time, the number of slides presented, the average rate of speaking, the number of filler words used and a list of those filter words. In an example, the summary report may also include a graph displaying the user's speaking rate over the entire length of the presentation. The graph may identify any periods during which the rate was outside the normal range and provide the slide the user was presenting during that time. This information could be very advantageous in assisting the user identify areas where more practice is needed.

In one implementation, the summary report may also provide the total speaking time out of the total rehearsal time. This may enable the user to identify the total amount of time they were silent during the presentation to help them identify pauses in speech. To further assist the user in identifying areas of improvements, the report may identify when during the presentation long pauses occurred (the time and/or slide number). The summary report may also include a summary of disfluencies during the presentation. This could list the disfluencies (or provide a summary if too many were identified) and may also provide information about when they occurred.

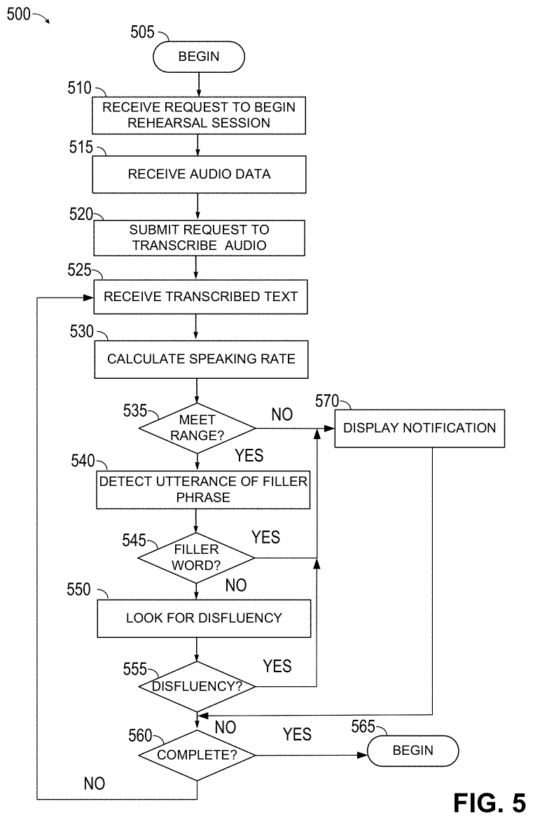

FIG. 5 is a flow diagram depicting an exemplary method 500 for providing speech rehearsal assistance. The method 500 may begin, at 505, and proceed to receive a request for a presentation or speech rehearsal session, at 510. This may occur, for example, when a user provides an input via a UI of an application or service that provides speech rehearsal assistance indicating that he/she desires to begin a rehearsal session. The input may be provided via a client device and be transmitted via a network to a speech rehearsal assistance service. Alternatively, the client device may include a software program that performs the speech rehearsal assistance.

Once a request for initiating a rehearsal session is received, the program or online service via which rehearsal assistance is being provided may begin receiving audio data from the user, at 515. The audio data may be captured by an input device such as a microphone connected to a client device. The client device may in turn transfer the audio data to the speech rehearsal assistance service for further processing. Once audio data is received, a request to transcribe the audio data may be submitted from the application or service (or the speech rehearsal assistance service) to a speech recognition engine for converting the spoken words to text, at 520. Speech recognition engines are known in the art and as such any known speech recognition mechanism that provides real-time speech recognition and conversion may be used. In an example, real-time speech recognition may be provided for audio portions that cover short periods of time (e.g., 1 to 3 seconds).

In response to the request, transcribed text corresponding to the audio data may be received, at 525. The transcribed text may be provided to the speech rehearsal assistance service in real-time as the user is speaking. In one implementation, the information relating to the transcribed text may include metadata such as when the text is received and the duration of the speech results. This information may help determine the amount of time during which the transcribed words were spoken. Determining the amount of time may be done by keeping track of a rolling buffer of last spoken audio data within a predetermined amount of time (e.g., 9 seconds of last spoken audio data). Furthermore, the total amount of time the user is in a rehearsal session can be determined by adding the total seconds for which a pacing score is calculated. That is since a pacing score is determined for every second, the total number of seconds may be calculated by adding the number of seconds together. The total amount of time may be then be used to calculate an average pacing score for the session.

In one implementation, for a given portion of the speech (e.g., 1 to 3 seconds of the speech), the number of words spoken and the amount of time during which the words are spoken can be determined from the transcribed text and the metadata received. Based on this information, the speaking rate can be calculated, at 530. This provides a real-time speaking rate that is calculated as the user is speaking, and as such provides a technical solution to the problem of not being able to identify which portions of the speech the user may need to work which may occur when the speaking rate is calculated at the end of a speaking session.

In one implementation, the speaking rate is calculated by determining the number of words in a given text portion and dividing that number by the amount of time during which the words were spoken. To provide a more accurate estimation that takes into account the length of the words spoken, an alternative approach may approximate the number of syllables in each word in the transcribed text and divide that number by the amount of time during which the words were spoken. This approach results in a calculation of syllables per unit of time (e.g., per minute) which may be more accurate than words per unit of time. The number of syllables in each word may be calculated using known grammatical rules. For example, the number of vowels in each word may determine the number of syllables, while specific rules may be applicable to diphthongs, triphthongs and the like.

In one implementation, features of the audio data may be utilized to determine the number of syllables in each word. For example, the audio data may be examined to identify audio parameters such as pitch and intensity to detect syllable nuclei in the voice. This is because syllable nuclei often correspond to vowels in words. In this manner, the number of vowels in the words of an audio portion may be determined without examining the transcribed words. Alternatively, this number may be compared with the number identified from the transcription to confirm accuracy. When using the audio file to determine the number of vowels, the calculated number of vowels may be divided by the total utterance time to calculate the speaking rate. The total utterance time may be the total time of the audio portion. Alternatively, the total utterance time may be calculated by examining the audio data to remove portions where there is no speaking voice. For example, time periods during which no voice is detected (e.g., the audio parameters do not correspond with speaking threshold) may be deducted from the total time. In this manner, the total utterance time accounts for long pauses in between words and sentences.

In one implementation, regardless of the approach used to calculate the speaking rate, previous speaking rates may be examined as part of the process to account for context and ensure accuracy. For example, a predetermined number of previously calculated speaking rates may be reviewed to ensure that the most recently calculated value is not an outlier. For example, if the previous 10 calculated speaking rates during this session ranged from 120 words per minute to 140 words per minute and the currently calculated rate is 180 words per minute, the current result may be an outlier. In such an instant, a notification may not be provided until the next audio portion is examined to confirm accuracy. It should be noted that to achieve this the previously calculated results would need to be stored. In one implementation, the results are stored, for example, as part of a user's profile either locally at the client device or in the cloud. Outliers may also be identified by using scaling and/or utilizing a Sigmoid function.

Once the speaking rate is calculated, method 500 may proceed to determine if the speaking rate is within an acceptable range, at 535. This may involve comparing the calculated speaking rate to a predetermined range. The predetermined range may be a standard range set by the speech rehearsal assistance service. Alternatively, the range may be customized based on the user's information. In one implementation, user's pace during previous rehearsal sessions may be stored and accessed to determine a normal range for each user. That is because different people may have different speaking paces and the rehearsal assistant may intend to identify abnormalities for each person. By looking at a person's prior history, the service can determine if they are exhibiting nervousness. To ensure compliance with privacy policies, the user may need to consent to their information being collected and stored to utilize this feature.

When it is determined, at 535, that the calculated rate is not within the predetermined range, a signal may be sent to the program via which the user's audio is being collected to display a notification to the user to inform of the abnormal pace, at 570. After displaying the notification and/or if it is determined that the speaking rate is within the acceptable range, method 500 may proceed to detect utterance of filler phrases in the received audio data, at 540. Filler words may include words, phrases and sounds that are not necessary to a spoken sentence or phrase and may include phrases such as like, basically, I mean, um, uh, and the like. To detect such filler words a first approach may simply examine the transcript of the audio portion to determine if any phrases or sounds identified as potential filler phrases exist in the transcribed text. However, this may not always identify the correct filler phrases, as some phrases may sometimes be a necessary part of a sentence. For example, the word “like” can be filler phrase or it can be necessary to a sentence. To distinguish such cases, a trained ML model may be used that examines the text and identifies which phrases are necessary to the text. To achieve this, context, meaning, grammar and the like may be taken into account. The trained ML model may be a natural language processing (NPL) model such as NPLs known in the art.

In one implementation, phonetic parameters of the audio data such as pitch, intensity, frequency, acoustics and the first, second and third formant may be examined. This is because these audio parameters are some of the basic spoken sounds. As a result, an approach may involve examining variation of these parameters (or a standard deviation of these parameters) to determine if the audio data corresponds to extended vowel sounds. These may be identifiable because when there is an extended vowel sound, pitch and formant stay relatively constant (e.g., their values do not vary much over a given time period). As a result, the standard deviation of these parameters may be examined across a given window of audio to detect potential extended vowel sounds. This may help identify phrases such as uh or um or situations where the user may be stretching a word. The potentially identified phrases may then be compared against the transcript to determine if they correspond to actual words. If they do and those words are not identified as potential filler phrases, then those may be overlooked. However, if they do not correspond to actual words in the transcript or if they correspond to words that may be filler phrases, then they may be identified as a detected utterance of a filler phrase.

Another approach for detecting utterance of filler phrases may involve the use of a deep neural network. For example, a masked convolutional or a recurrent convolutional neural network may be developed that examines every time stamp in every audio frame of the audio data across a certain window to determine how to classify the words in the audio. This may involve providing the values of pitch, and the first, second and third formants to the deep neural network to have the neural network determine if they correspond with filler words. This approach may be similar to a heuristic approach in that it utilizes a windowed mask to examine the entire audio stream and identify filler phrases.

After examining the transcript and audio data for filler words, method 500 may proceed to determine, at 545, if any filler phrases are detected. When it is determined that one or more filler phrases were uttered, method 500 may proceed to enable display of a notification, at 570. After displaying the notification and/or if no filler phrases are detected, method 500 may proceed to look for disfluency in the speech, at 550. This may include looking for inflections by examining the audio data for extended pauses and may also involve utilizing an ML model to examine the sentences to determine if one or more words are repeated, some sentences are in complete, and the like. For example, if the user makes a long pause in the middle of a sentence, then repeated one or more words, this may be signaled as a disfluency.

When disfluency is detected, method 500 may proceed to enable displaying a notification at 570 to notify the user of the disfluency identified. After displaying the notification and/or when no disfluency is identified, method 500 may proceed to determine, at 560, if the rehearsal session is complete. When the session is determined as being complete, method 500 may proceed to end, at 560. Otherwise, method 500 may return to step 515 to receive the next portion of the audio data and repeat the process.

It should be noted that the models providing filler phrase or disfluency detection may be hosted locally on the client or remotely in the cloud. In one implementation, some models are hosted locally, while others are stored in the cloud. This enables the client device to provide some speech rehearsal assistance even when the client is not connected to a network. Once the client connects to the network, however, the application may be able to provide better and more complete speech rehearsal assistance.

Thus, in different implementations, a technical solution may be provided for enabling speech or presentation rehearsal assistance in real time. Various mechanisms and ML models may be used to examine audio parameters of an audio file containing the user's spoken words to calculate the speaker's pace (e.g. speaking rate), detect utterance of filler phrases and/or identify disfluency in speech. The calculations may then be used to provide notifications to the user anytime any issues with the speech are detected. As a result, accurate real-time information may be provided to a user as they are rehearsing a speech to enable them to improve their speaking.

FIG. 6 is a block diagram 600 illustrating an example software architecture 602, various portions of which may be used in conjunction with various hardware architectures herein described, which may implement any of the above-described features. FIG. 6 is a non-limiting example of a software architecture and it will be appreciated that many other architectures may be implemented to facilitate the functionality described herein. The software architecture 602 may execute on hardware such as client devices, native application provider, web servers, server clusters, external services, and other servers. A representative hardware layer 604 includes a processing unit 606 and associated executable instructions 608. The executable instructions 608 represent executable instructions of the software architecture 602, including implementation of the methods, modules and so forth described herein.

The hardware layer 604 also includes a memory/storage 610, which also includes the executable instructions 608 and accompanying data. The hardware layer 604 may also include other hardware modules 612. Instructions 608 held by processing unit 608 may be portions of instructions 608 held by the memory/storage 610.

The example software architecture 602 may be conceptualized as layers, each providing various functionality. For example, the software architecture 602 may include layers and components such as an operating system (OS) 614, libraries 616, frameworks 618, applications 620, and a presentation layer 624. Operationally, the applications 620 and/or other components within the layers may invoke API calls 624 to other layers and receive corresponding results 626. The layers illustrated are representative in nature and other software architectures may include additional or different layers. For example, some mobile or special purpose operating systems may not provide the frameworks/middleware 618.

The OS 614 may manage hardware resources and provide common services. The OS 614 may include, for example, a kernel 628, services 630, and drivers 632. The kernel 628 may act as an abstraction layer between the hardware layer 604 and other software layers. For example, the kernel 628 may be responsible for memory management, processor management (for example, scheduling), component management, networking, security settings, and so on. The services 630 may provide other common services for the other software layers. The drivers 632 may be responsible for controlling or interfacing with the underlying hardware layer 604. For instance, the drivers 632 may include display drivers, camera drivers, memory/storage drivers, peripheral device drivers (for example, via Universal Serial Bus (USB)), network and/or wireless communication drivers, audio drivers, and so forth depending on the hardware and/or software configuration.

The libraries 616 may provide a common infrastructure that may be used by the applications 620 and/or other components and/or layers. The libraries 616 typically provide functionality for use by other software modules to perform tasks, rather than rather than interacting directly with the OS 614. The libraries 616 may include system libraries 634 (for example, C standard library) that may provide functions such as memory allocation, string manipulation, file operations. In addition, the libraries 616 may include API libraries 636 such as media libraries (for example, supporting presentation and manipulation of image, sound, and/or video data formats), graphics libraries (for example, an OpenGL library for rendering 2D and 3D graphics on a display), database libraries (for example, SQLite or other relational database functions), and web libraries (for example, WebKit that may provide web browsing functionality). The libraries 616 may also include a wide variety of other libraries 638 to provide many functions for applications 620 and other software modules.

The frameworks 618 (also sometimes referred to as middleware) provide a higher-level common infrastructure that may be used by the applications 620 and/or other software modules. For example, the frameworks 618 may provide various graphic user interface (GUI) functions, high-level resource management, or high-level location services. The frameworks 618 may provide a broad spectrum of other APIs for applications 620 and/or other software modules.

The applications 620 include built-in applications 620 and/or third-party applications 622. Examples of built-in applications 620 may include, but are not limited to, a contacts application, a browser application, a location application, a media application, a messaging application, and/or a game application. Third-party applications 622 may include any applications developed by an entity other than the vendor of the particular system. The applications 620 may use functions available via OS 614, libraries 616, frameworks 618, and presentation layer 624 to create user interfaces to interact with users.

Some software architectures use virtual machines, as illustrated by a virtual machine 628. The virtual machine 628 provides an execution environment where applications/modules can execute as if they were executing on a hardware machine (such as the machine 600 of FIG. 6, for example). The virtual machine 628 may be hosted by a host OS (for example, OS 614) or hypervisor, and may have a virtual machine monitor 626 which manages operation of the virtual machine 628 and interoperation with the host operating system. A software architecture, which may be different from software architecture 602 outside of the virtual machine, executes within the virtual machine 628 such as an OS 650, libraries 652, frameworks 654, applications 656, and/or a presentation layer 658.

FIG. 7 is a block diagram illustrating components of an example machine 700 configured to read instructions from a machine-readable medium (for example, a machine-readable storage medium) and perform any of the features described herein. The example machine 700 is in a form of a computer system, within which instructions 716 (for example, in the form of software components) for causing the machine 700 to perform any of the features described herein may be executed. As such, the instructions 716 may be used to implement methods or components described herein. The instructions 716 cause unprogrammed and/or unconfigured machine 700 to operate as a particular machine configured to carry out the described features. The machine 700 may be configured to operate as a standalone device or may be coupled (for example, networked) to other machines. In a networked deployment, the machine 700 may operate in the capacity of a server machine or a client machine in a server-client network environment, or as a node in a peer-to-peer or distributed network environment. Machine 700 may be embodied as, for example, a server computer, a client computer, a personal computer (PC), a tablet computer, a laptop computer, a netbook, a set-top box (STB), a gaming and/or entertainment system, a smart phone, a mobile device, a wearable device (for example, a smart watch), and an Internet of Things (IoT) device. Further, although only a single machine 700 is illustrated, the term “machine” includes a collection of machines that individually or jointly execute the instructions 716.

The machine 700 may include processors 710, memory 730, and I/O components 750, which may be communicatively coupled via, for example, a bus 702. The bus 702 may include multiple buses coupling various elements of machine 700 via various bus technologies and protocols. In an example, the processors 710 (including, for example, a central processing unit (CPU), a graphics processing unit (GPU), a digital signal processor (DSP), an ASIC, or a suitable combination thereof) may include one or more processors 712a to 712n that may execute the instructions 716 and process data. In some examples, one or more processors 710 may execute instructions provided or identified by one or more other processors 710. The term “processor” includes a multi-core processor including cores that may execute instructions contemporaneously. Although FIG. 7 shows multiple processors, the machine 700 may include a single processor with a single core, a single processor with multiple cores (for example, a multi-core processor), multiple processors each with a single core, multiple processors each with multiple cores, or any combination thereof. In some examples, the machine 700 may include multiple processors distributed among multiple machines.

The memory/storage 730 may include a main memory 732, a static memory 734, or other memory, and a storage unit 736, both accessible to the processors 710 such as via the bus 702. The storage unit 736 and memory 732, 734 store instructions 716 embodying any one or more of the functions described herein. The memory/storage 730 may also store temporary, intermediate, and/or long-term data for processors 710. The instructions 716 may also reside, completely or partially, within the memory 732, 734, within the storage unit 736, within at least one of the processors 710 (for example, within a command buffer or cache memory), within memory at least one of I/O components 750, or any suitable combination thereof, during execution thereof. Accordingly, the memory 732, 734, the storage unit 736, memory in processors 710, and memory in I/O components 750 are examples of machine-readable media.

As used herein, “machine-readable medium” refers to a device able to temporarily or permanently store instructions and data that cause machine 700 to operate in a specific fashion. The term “machine-readable medium,” as used herein, does not encompass transitory electrical or electromagnetic signals per se (such as on a carrier wave propagating through a medium); the term “machine-readable medium” may therefore be considered tangible and non-transitory. Non-limiting examples of a non-transitory, tangible machine-readable medium may include, but are not limited to, nonvolatile memory (such as flash memory or read-only memory (ROM)), volatile memory (such as a static random-access memory (RAM) or a dynamic RAM), buffer memory, cache memory, optical storage media, magnetic storage media and devices, network-accessible or cloud storage, other types of storage, and/or any suitable combination thereof. The term “machine-readable medium” applies to a single medium, or combination of multiple media, used to store instructions (for example, instructions 716) for execution by a machine 700 such that the instructions, when executed by one or more processors 710 of the machine 700, cause the machine 700 to perform and one or more of the features described herein. Accordingly, a “machine-readable medium” may refer to a single storage device, as well as “cloud-based” storage systems or storage networks that include multiple storage apparatus or devices.

The I/O components 750 may include a wide variety of hardware components adapted to receive input, provide output, produce output, transmit information, exchange information, capture measurements, and so on. The specific I/O components 750 included in a particular machine will depend on the type and/or function of the machine. For example, mobile devices such as mobile phones may include a touch input device, whereas a headless server or IoT device may not include such a touch input device. The particular examples of I/O components illustrated in FIG. 7 are in no way limiting, and other types of components may be included in machine 700. The grouping of I/O components 750 are merely for simplifying this discussion, and the grouping is in no way limiting. In various examples, the I/O components 750 may include user output components 752 and user input components 754. User output components 752 may include, for example, display components for displaying information (for example, a liquid crystal display (LCD) or a projector), acoustic components (for example, speakers), haptic components (for example, a vibratory motor or force-feedback device), and/or other signal generators. User input components 754 may include, for example, alphanumeric input components (for example, a keyboard or a touch screen), pointing components (for example, a mouse device, a touchpad, or another pointing instrument), and/or tactile input components (for example, a physical button or a touch screen that provides location and/or force of touches or touch gestures) configured for receiving various user inputs, such as user commands and/or selections.

In some examples, the I/O components 750 may include biometric components 756 and/or position components 762, among a wide array of other environmental sensor components. The biometric components 756 may include, for example, components to detect body expressions (for example, facial expressions, vocal expressions, hand or body gestures, or eye tracking), measure biosignals (for example, heart rate or brain waves), and identify a person (for example, via voice-, retina-, and/or facial-based identification). The position components 762 may include, for example, location sensors (for example, a Global Position System (GPS) receiver), altitude sensors (for example, an air pressure sensor from which altitude may be derived), and/or orientation sensors (for example, magnetometers).

The I/O components 750 may include communication components 764, implementing a wide variety of technologies operable to couple the machine 700 to network(s) 770 and/or device(s) 780 via respective communicative couplings 772 and 782. The communication components 764 may include one or more network interface components or other suitable devices to interface with the network(s) 770. The communication components 764 may include, for example, components adapted to provide wired communication, wireless communication, cellular communication, Near Field Communication (NFC), Bluetooth communication, Wi-Fi, and/or communication via other modalities. The device(s) 780 may include other machines or various peripheral devices (for example, coupled via USB).

In some examples, the communication components 764 may detect identifiers or include components adapted to detect identifiers. For example, the communication components 664 may include Radio Frequency Identification (RFID) tag readers, NFC detectors, optical sensors (for example, one- or multi-dimensional bar codes, or other optical codes), and/or acoustic detectors (for example, microphones to identify tagged audio signals). In some examples, location information may be determined based on information from the communication components 762, such as, but not limited to, geo-location via Internet Protocol (IP) address, location via Wi-Fi, cellular, NFC, Bluetooth, or other wireless station identification and/or signal triangulation.

While various embodiments have been described, the description is intended to be exemplary, rather than limiting, and it is understood that many more embodiments and implementations are possible that are within the scope of the embodiments. Although many possible combinations of features are shown in the accompanying figures and discussed in this detailed description, many other combinations of the disclosed features are possible. Any feature of any embodiment may be used in combination with or substituted for any other feature or element in any other embodiment unless specifically restricted. Therefore, it will be understood that any of the features shown and/or discussed in the present disclosure may be implemented together in any suitable combination. Accordingly, the embodiments are not to be restricted except in light of the attached claims and their equivalents. Also, various modifications and changes may be made within the scope of the attached claims.

Generally, functions described herein (for example, the features illustrated in FIGS. 1-5) can be implemented using software, firmware, hardware (for example, fixed logic, finite state machines, and/or other circuits), or a combination of these implementations. In the case of a software implementation, program code performs specified tasks when executed on a processor (for example, a CPU or CPUs). The program code can be stored in one or more machine-readable memory devices. The features of the techniques described herein are system-independent, meaning that the techniques may be implemented on a variety of computing systems having a variety of processors. For example, implementations may include an entity (for example, software) that causes hardware to perform operations, e.g., processors functional blocks, and so on. For example, a hardware device may include a machine-readable medium that may be configured to maintain instructions that cause the hardware device, including an operating system executed thereon and associated hardware, to perform operations. Thus, the instructions may function to configure an operating system and associated hardware to perform the operations and thereby configure or otherwise adapt a hardware device to perform functions described above. The instructions may be provided by the machine-readable medium through a variety of different configurations to hardware elements that execute the instructions.

In the following, further features, characteristics and advantages of the invention will be described by means of items:

Item 1. A data processing system comprising:
a processor; and
a memory in communication with the processor, the memory comprising executable instructions that, when executed by the processor, cause the data processing system to perform functions of:
   receiving audio data from a speech rehearsal session over a network, the speech rehearsal session being performed for a digital presentation;
   receiving a transcript for the audio data, the transcript including a plurality of words spoken during the speech rehearsal session;
   determining a number of syllables in each of the plurality of words;
   calculating a speaking rate based at least in part on the number of syllables;
   determining if the speaking rate is within a threshold range; and
   enabling display of a notification on a display device in real time, if the speaking rate falls outside the threshold range.

Item 2. The data processing system of item 1, wherein the transcript includes metadata from which a time period for a duration of the audio data may be calculated.

Item 3. The data processing system of item 1 or 2, wherein the speaking rate is calculated based at least in part on the time period.

Item 4. The data processing system of any of the preceding items, wherein the number of syllables is determined by detecting a number of syllable nuclei in the plurality of words.

Item 5. The data processing system of any of the preceding items, wherein the syllable nuclei is detected by examining a plurality of parameters of the audio data, the plurality of parameters including pitch and intensity.

Item 6. The data processing system of any of the preceding items, wherein the executable instructions, when executed by the processor, further cause the data processing system to:
determine an utterance time based on the audio data; and
calculate the speaking rate based at least in part on the number syllable nuclei and the utterance time.

Item 7. The data processing system of any of the preceding items, wherein the threshold range is determined based on a historical information relating to a user who is conducting the speech rehearsal session.

Item 8. A data processing system comprising:
a processor; and
a memory in communication with the processor, the memory comprising executable instructions that, when executed by the processor, cause the data processing system to perform functions of:
   receiving audio data from a speech rehearsal session over a network;
   receiving a transcript for the audio data, the transcript including a plurality of words spoken during the speech rehearsal session;
   detecting utterance of a filler phrase or sound during the speech rehearsal session using at least in part a machine learning model trained for identifying filler phrases and sounds in a text;
   upon detecting the utterance of the filler phrase or sound, enabling real time display of a notification on a display device;
   wherein detecting the utterance of the filler phrase or sound is done based on at least one of the transcript of the audio data or the audio data.

Item 9. The data processing system of item 8, wherein detecting the utterance of the filler phrase or sound based on the audio data includes examining parameters of the audio data including pitch or intensity.

Item 10. The data processing system of items 8 or 9, wherein detecting the utterance of the filler phrase or sound includes examining parameters of the audio data including pitch, intensity, or frequency using a deep neural network.

Item 11. The data processing system of any of items 8-10, wherein the machine learning model is a natural language processing model utilized to identify if a word is part of a phrase or sentence.

Item 12. The data processing system of any of items 8-11, wherein the executable instructions, when executed by the processor, further cause the data processing system to detect disfluency during the speech rehearsal session based at least in part on the audio data.

Item 13. The data processing system of any of items 8-12, wherein detecting disfluency includes detecting an inflection point.

Item 14. The data processing system of any of items 8-13, wherein the notification includes a notice about the detected disfluency.

Item 15. A method for providing speech rehearsal assistant during a presentation rehearsal comprising:
receiving audio data from a speech rehearsal session over a network;
receiving a transcript for the audio data, the transcript including a plurality of words spoken during the speech rehearsal session;
calculating a real time speaking rate for the speech rehearsal session;
determining if the speaking rate is within a threshold range;
detecting utterance of a filler phrase or sound during the speech rehearsal session using at least in part a machine learning model trained for identifying filler phrases and sounds in a text; and
upon at least one of determining the speaking rate falls outside the threshold range or detecting the utterance of the filler phrase or sound, enabling real time display of a notification on a display device.

Item 16. The method of item 15, wherein the transcript includes metadata from which a time period for a duration of the audio data may be calculated and the speaking rate is calculated based at least in part on the time period.

Item 17. The method of item 15 or 16, wherein the speaking rate is calculated based in part on a number of syllables detected in the plurality of words.

Item 18. The method of any of items 15-17, wherein the number of syllables is determined by detecting a number of syllable nuclei in the plurality of words.

Item 19. The method of any of the items 15-18, wherein detecting the utterance of the filler phrase or sound includes examining parameters of the audio data including pitch, intensity, or frequency using a deep neural network.

Item 20. The method of any of the items 15-19, further comprising detecting disfluency during the speech rehearsal session based at least in part on the audio data.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows, and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein.

Relational terms such as first and second and the like may be used solely to distinguish one entity or action from another without necessarily requiring or implying any actual such relationship or order between such entities or actions. The terms “comprises,” “comprising,” and any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “a” or “an” does not, without further constraints, preclude the existence of additional identical elements in the process, method, article, or apparatus that comprises the element.

The Abstract of the Disclosure is provided to allow the reader to quickly identify the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that any claim requires more features than the claim expressly recites. Rather, as the following claims reflect, inventive subject matter lies in less than all features of a single disclosed example. Thus, the following claims are hereby incorporated into the Detailed Description, with each claim standing on its own as a separately claimed subject matter.

What is claimed is:

1. A data processing system comprising:
a processor; and
a memory in communication with the processor, the memory comprising executable instructions that, when executed by the processor, cause the data processing system to perform functions of:
receiving audio data from a speech rehearsal session over a network, the speech rehearsal session being performed for a digital presentation;
receiving a transcript for the audio data, the transcript including a plurality of words spoken during the speech rehearsal session;
determining a number of syllables in each of the plurality of words;
calculating a speaking rate based at least in part on the number of syllables;
determining if the speaking rate is within a threshold range; and
enabling display of a notification on a display device in real time, if the speaking rate falls outside the threshold range.

2. The data processing system of claim 1, wherein the transcript includes metadata from which a time period for a duration of the audio data may be calculated.

3. The data processing system of claim 2, wherein the speaking rate is calculated based at least in part on the time period.

4. The data processing system of claim 1, wherein the number of syllables is determined by detecting a number of syllable nuclei in the plurality of words.

5. The data processing system of claim 4, wherein the syllable nuclei is detected by examining a plurality of parameters of the audio data, the plurality of parameters including pitch and intensity.

6. The data processing system of claim 5, wherein the executable instructions, when executed by the processor, further cause the data processing system to:
determine an utterance time based on the audio data; and
calculate the speaking rate based at least in part on the number syllable nuclei and the utterance time.

7. The data processing system of claim 1, wherein the threshold range is determined based on a historical information relating to a user who is conducting the speech rehearsal session.

8. A data processing system comprising:
a processor; and
a memory in communication with the processor, the memory comprising executable instructions that, when executed by the processor, cause the data processing system to perform functions of:
receiving audio data from a speech rehearsal session over a network;
receiving a transcript for the audio data, the transcript including a plurality of words spoken during the speech rehearsal session;
detecting utterance of a filler phrase or sound during the speech rehearsal session using at least in part a machine learning model trained for identifying filler phrases and sounds in a text;
upon detecting the utterance of the filler phrase or sound, enabling real time display of a notification on a display device;
wherein detecting the utterance of the filler phrase or sound is done based on at least one of the transcript of the audio data or the audio data.

9. The data processing system of claim 8, wherein detecting the utterance of the filler phrase or sound based on the audio data includes examining parameters of the audio data including pitch or intensity.

10. The data processing system of claim 9, wherein detecting the utterance of the filler phrase or sound includes examining parameters of the audio data including pitch, intensity, or frequency using a deep neural network.

11. The data processing system of claim 8, wherein the machine learning model is a natural language processing model utilized to identify if a word is part of a phrase or sentence.

12. The data processing system of claim 8, wherein the executable instructions, when executed by the processor, further cause the data processing system to detect disfluency during the speech rehearsal session based at least in part on the audio data.

13. The data processing system of claim 12, wherein detecting disfluency includes detecting an inflection point.

14. The data processing system of claim 12, wherein the notification includes a notice about the detected disfluency.

15. A method for providing speech rehearsal assistant during a presentation rehearsal comprising:
receiving audio data from a speech rehearsal session over a network;
receiving a transcript for the audio data, the transcript including a plurality of words spoken during the speech rehearsal session;
calculating a real time speaking rate for the speech rehearsal session;
determining if the speaking rate is within a threshold range;
detecting utterance of a filler phrase or sound during the speech rehearsal session using at least in part a machine learning model trained for identifying filler phrases and sounds in a text; and
upon at least one of determining the speaking rate falls outside the threshold range or detecting the utterance of the filler phrase or sound, enabling real time display of a notification on a display device.

16. The method of claim 15, wherein the transcript includes metadata from which a time period for a duration of the audio data may be calculated and the speaking rate is calculated based at least in part on the time period.

17. The method of claim 15, wherein the speaking rate is calculated based in part on a number of syllables detected in the plurality of words.

18. The method of claim 17, wherein the number of syllables is determined by detecting a number of syllable nuclei in the plurality of words.

19. The method of claim 15, wherein detecting the utterance of the filler phrase or sound includes examining parameters of the audio data including pitch, intensity, or frequency using a deep neural network.

20. The method of claim 15, further comprising detecting disfluency during the speech rehearsal session based at least in part on the audio data.
